(19) United States
(12) Patent Application Publication
(10) Pub. No.: US 2004/0156977 A1
(43) Pub. Date: Aug. 12, 2004

(54) Method for production of food products coated in a material made from protein and hydrocolloid materials

(76) Inventor: Gilles Bocabeille, La Chapelle Chaumee (FR)

Correspondence Address: HARNESS, DICKEY & PIERCE, P.L.C., P.O. BOX 828, BLOOMFIELD HILLS, MI, 48303, US

(21) Appl. No.: 10/481,833

(22) PCT Filed: Jun. 18, 2002
(86) PCT No.: PCT/FR02/02100

(30) Foreign Application Priority Data
Jun. 22, 2001 (FR) 01/08274

(51) Int. Cl. A23L 1/31

(52) U.S. Cl. 426/641

(57) ABSTRACT

The invention relates to a method for the preparation of food products, for example, sausages, comprising a base coated in a garnishing and preserving material. Said method comprises preparing the material, made from vegetable protein and hydrocolloid to give a ratio (protein/hydrocolloid) less than or equal to 1, substituting calcium acetate for sodium acetate in the base, then adding alcohol and an acidifying agent to the calcium gelification bath. The invention also relates to a product obtained by the above method.

The present invention relates to a method for preparation of food products coated with a material constituted of vegetal protein and hydrocolloid, as well as food products that can be obtained according to this method.

Document WO 99/55165 is already known, concerning food products, for example of the sausage type, with contents, usually meat, coated in a material forming a skin, constituted essentially of protein and hydrocolloid.

However, despite the proportion of protein in the coating material, much greater than that of the hydrocolloid, the food product resulting from the method described in this document does not have sufficient stability with time.

Moreover, the very low hydrocolloid concentration does not allow conservation of a food product resulting from this method having adequate stability during cooking, for example in a frying pan or on the embers of a barbecue.

In fact, if the food product is not cooked quickly within about 2 to 12 hours after production, the product coating material decomposes rapidly. It softens around the meat, since the sodic flux is too high in the meat, and is not buffered.

The water content is too high in the coating material and this makes its resistance more fragile several days after production.

Furthermore, despite its high proportion of total protein, the coating material includes too low a quantity of proteins that are insoluble in water.

Therefore, there is a need for a method for production of food products coated in a garnishing and preserving material constituted of vegetal protein and hydrocolloid avoiding the disadvantages described above.

Thus the aim of the invention is a method for producing a comestible product capable of being presented in different geometrical shapes, comprising a base made of animal meat and/or milk products, possibly mixed with vegetables and/or fruits, said base being covered totally or partially with a garnishing and preserving material, said material including at least one vegetal protein and at least one hydrocolloid, said method consisting of:

mixing the protein and the hydrocolloid in an aqueous medium in such a way as to obtain the garnishing and preserving material under a form able to be extruded,

preparing the base,

coating the prepared base with the garnishing and preserving material,

then carrying out a chemical process by calcic gelling of the coated base, in an aqueous bath essentially comprising a divalent cation,

characterised in that before mixing together the vegetal protein and the hydrocolloid, the vegetal protein is first of all dispersed in distilled water in such a way as to recuperate the insolubilized soaked phase, said insolubilized phase then being dispersed and hydrated in heated water already including the hydrocolloid, the final mixture (protein-hydrocolloid), wherein the protein/hydrocolloid ratio is less than or equal to 1, then being pasteurised,

in that, in the prepared base, sodium acetate is substituted by calcium acetate, and

in that the gelification bath includes methanol and/or ethanol and has an acid pH.

On the one hand the present invention has the advantage, because of the presence of the hydrocolloid, of providing instant gelling of the coating material when the latter is put in contact with the gelification bath and, on the other hand, because of the presence of vegetal protein, of allowing coagulation of this coating material thus causing it to retract simultaneously with the meat during cooking.

Furthermore, the presence of a sufficient quantity of protein network insoluble in water, in the coating and preserving material, provides maximum economy of the functionality of all the protein present, by consuming less protein while still making it possible to obtain food products with a satiny appearance similar to that obtained with natural casings of animal origin, such as those of sheep.

Finally, the substitution in the base of sodium acetate by calcium acetate moreover allows the chemical medium of the base to be buffered; it usually has a very high sodic concentration from the addition of different sodic salts know for their anti-oxidant, preserving or bacteriostatic effect, thus resulting in good stabilisation of the coating material with length of time, and therefore not separating from the base during cooking.

A further aim of the invention is a comestible product able to be presented in different geometric shapes, able to be obtained according to the method described above.

This product comprises a garnishing and preserving material, and a base constituted of animal meat and/or milk products possibly mixed with vegetables and/or fruit.

This product is characterised by the fact that said material includes a vegetal protein and a hydrocolloid with a protein/hydrocolloid ratio less than or equal to 1, and that, in the base, sodium acetate is substituted by calcium acetate.

According to a preferred embodiment of the invention, the gelification bath essentially comprises calcium acetate, and the acid pH of this bath is obtained by the presence of at least one compound chosen from amongst citric acid, lactic acid, acetic acid or a mixture of these.

The gelification bath can include different additives chosen from amongst antifungal agents, preserving agents, colouring agents and perfuming agents. Equally well, the base can include different additives chosen from amongst preserving agents, colouring agents and antioxidant agents, ferments and their mixture.

Preferably, the acidifying component is present in a quantity ranging from 0.5% to 3% by weight, and more preferably from 1 to 1.5% by weight relative to the total weight of the gelification bath. Methanol and/or ethanol can be present in a quantity ranging from 5% to 20%, and preferably from 10% to 15% by weight relative to the total weight of the gelification bath.

Calcium acetate can be present in a quantity ranging from 0.10% to 0.6% by weight, and preferably from 0.25% to 0.4% by weight relative to the total weight of the base. Moreover, it can be present in a quantity ranging from 10% to 30% by weight, and preferably from 20% to 27% by weight relative to the total weight of the bath.

Furthermore, the mixture (protein-hydrocolloid) can include bi-calcium phosphate in a quantity ranging from 0.1% to 0.4% by weight, and preferably of 0.2% by weight relative to the total weight of the final mixture (protein-hydrocolloid).

The presence of bi-calcium phosphate improves the result for a coated comestible product. In fact, bi-calcium phosphate incorporated in the protein-hydrocolloid mixture before pasteurisation makes it possible, when it is put in contact with the acid bath, to precipitate out the hydrocolloid under calcic form within the comestible product.

Furthermore, the presence of bi-calcium phosphate makes it possible to reinforce, particularly with length of time, the visual appearance of comestible products resulting from the method according to the invention.

The vegetal protein can be chosen from amongst gluten protein, pea protein, lupine protein, soybean, protein and their mixture.

The hydrocolloid can be chosen from amongst the alginates, the pectates, such as sodium alginate or sodium pectate, and their mixture.

Preferably, the recuperated insolubilized protein phase is present in a quantity ranging from 20 to 45% by weight, and preferably from 20 to 35% by weight relative to the total weight of the garnishing and preserving material.

The present invention will now be described using the following examples of embodiments, evidently provided only as examples, and which are non-limiting.

The preparation of the mixture (protein-hydrocolloid) is carried out according to the following method:

Preparation of the Vegetal Protein

For a few minutes (about 2 to 3 minutes) at ambient temperature (about 20-50° C.), the vegetal protein under powder form is mixed with distilled water so that the proteins are completely dissolved according, for example, to the following proportions:

gluten protein 160 gm/1000 gm water

pea protein 200 gm/1000 gm water

or lupine protein 350 gm/1000 gm water

or soybean protein 28 gm/1000 gm water

This mixture is then left to rest for about 30 minutes until a multiphase medium is obtained.

On the surface of the decanted mixture, the vegetal protein is recuperated in the form of a paste. This paste is essentially constituted of a dissolved proteinic network. This recuperated paste is then concentrated, according to techniques known to those skilled in the art, in order to obtain an insoluble protein concentrated at about 33%.

Preparation of the Hydrocolloid

The hydrocolloid is quickly mixed with water heated to about 75° C., for about 1 minute, according to the following proportions, for example:

sodium alginate 50 gm/830 gm water

or sodium pectate 30 gm/850 gm water,

and the concentrated vegetal protein paste is incorporated.

The entire mixture is then heated to about 75° C. for about 15 minutes to be pasteurised.

The obtained mixture (vegetal protein—hydrocolloid) when cooled, available in paste form, is then packed into sterile pouches to be stored before utilisation.

The obtained mixture can be chosen from among a few following examples:

| a) example 1 | |
|---|---|
| Alginate | 5% |
| Gluten protein | 3.94% |
| Water | 91.06% |
| b) example 2 | |
| Pectate | 3.1% |
| Gluten protein | 3.00% |
| Water | 93.90% |
| C) example 3 | |
| Alginate | 3% |
| Pea protein | 2.8% |
| Water | 94.2% |

Preparation of the Base

The base, constituted of meat or fish, or milk products, possibly with the addition of vegetables and/or fruit, in which lipidic products may be present, moreover includes many salts or acid salts usually complexed with the sodium ion intended in particular for preservation of the base.

Amongst these salts, for example, one can find sodium ascorbate, sodium nitrites, sodium nitrates, sodium acetate, sodium lactate, sodium erythorbate, carmine colouring on a sodium hydrate base support, together with sodium chloride which itself alone is already present at about 1.7 to 2% of the total weight of the coated base.

Consequently, the “sodic pressure” of the base is significant.

Furthermore, the replacement of sodium acetate by calcium acetate in the base makes it possible to buffer the base, already rich in sodium ions and, as a result, to cancel this “sodic pressure”.

Preferably, calcium acetate is present in the base in a proportion ranging from 0.25 to 0.4% by weight relative to the total weight of the base, and relative to the concentration of salts in the base.

Preparation of the gelification bath
At ambient temperature (20-25° C.), the following
compounds are dissolved:

| | |
|---|---|
| Water | 890 gm |
| Calcium acetate | 270 gm - saturating agent |
| | for free calcium |
| Citric acid | 10 gm - acidifying agent |
| | to obtain a final pH ranging from about 3 to 4.5 |
| Brandy Alcohol | 100 gm - tensor effect on |
| | the coating material and antibacterial effect for the |
| | preparation method as a whole. |
| Potassium sorbate | 10 gm - anti-fungal |
| | effect in an acid pH medium. |

The calcium acetate is solubilized until saturation is reached.

In the gelification bath, calcium acetate is used because it is much more soluble than the sodium lactate used usually in prior art.

In fact, calcium lactate can be solubilized at 27% by weight relative to the total weight of the bath, whereas calcium lactate can only be solubilized at 5.5%.

As a consequence, the calcic concentration in the bath is definitely higher.

Furthermore, an acidifying agent is added in the bath to raise the solubilization of the calcium acetate.

The presence of ethanol and/or methanol in the bath makes it possible both to stretch the film of coating and preserving material on the base and to stabilize the bath microbiologically over a long working period.

The operation of the preparation method for comestible products of different geometric shapes, for example of the sausage type, uses a known co-extrusion method.

The base, coated with the garnishing and preserving material, is soaked in the gelification bath where two different and complementary gellings are produced simultaneously:

the first, by soaking with the free calcium ions abundantly present in the bath; from the time of immersion, an external film of a complex (of hydrocolloid-Ca⁺⁺) is formed on the external surface of the mixture coating the base and,

the second, slightly slower, by freeing of the calcium ions present in the base, due to the acid pH of the bath.

The gelling of the coated base is obtained due to the presence of the hydrocolloid that hardens immediately in contact with the calcic bath. Furthermore, this gelling is thermo-stable.

When taken out of the bath, the base with the garnishing and preserving coating then passes into a device intended to pinch all of it progressively in such a way as to flatten it.

At this stage, the acid gelification, still active, represents an important advantage, because it creates a link between the two layers of coating material, making it possible to obtain portions that are perfectly closed at their ends.

The product obtained at the end of the method according to the invention has a satiny appearance conforming with the appearance of equivalent products pushed into natural casing, for example those of sheep.

Such an appearance is obtained because of the presence of the non-soluble proteinic network of the vegetal protein. Furthermore, the vegetal protein is of interest because it coagulates in contact with the calcic bath, and consequently retracts on the coated base during cooking, thus avoiding separation of the coating material and the base.

1. Method for producing a comestible product capable of being presented in different geometrical shapes, comprising a base made of animal meat and/or milk products, possibly mixed with vegetables and/or fruits, said base being covered totally or partially with a garnishing and preserving material, said material including at least one vegetal protein and at least one hydrocolloid, said method consisting of:
mixing the protein and the hydrocolloid in an aqueous medium in such a way as to obtain the garnishing and preserving material under a form able to be extruded,
preparing the base,
coating the prepared base with the garnishing and preserving material,
then carrying out a chemical processing by calcic gelling of the coated base, in an aqueous bath essentially comprising a divalent cation,
characterised in that before mixing together the vegetal protein and the hydrocolloid, the vegetal protein is first of all dispersed in distilled water in such a way as to recuperate the insolubilized soaked phase, said insolubilized phase then being dispersed and hydrated in heated water already including the hydrocolloid, the final mixture (protein-hydrocolloid), wherein the protein/hydrocolloid ratio is less than or equal to 1, then being pasteurised,
in that, in the prepared base, sodium acetate is substituted by calcium acetate, and
in that the gelification bath includes methanol and/or ethanol and has an acid pH.

2. Method according to claim 1, characterised in that the gelification bath essentially comprises calcium acetate.

3. Method according to claim 1, characterised in that the acid pH of the bath is obtained by the presence of at least one acidifying component chosen from among citric acid, lactic acid, acetic acid or a mixture of these.

4. Method according to claim 3, characterised in that the acidifying compound is present in a quantity ranging from 0.5 to 3% by weight, and preferably from 1 to 1.5% by weight relative to the total weight of the bath.

5. Method according to claim 1 characterised in that the methanol and/or ethanol is present in a quantity ranging from 5 to 20%, and preferably from 10 to 15% by weight relative to the total weight of the bath.

6. Method according to claim 1, characterised in that the calcium acetate is present in a quantity ranging from 0.1 to 0.6%, and preferably from 0.25 to 0.4% by weight relative to the total weight of the base.

7. Method according to claim 2, characterised in that the calcium acetate is present in a quantity ranging from 10% to 30% by weight, and preferably from 20% to 27% by weight relative to the total weight of the bath.

8. Method according to claim 1, characterised in that bi-calcium phosphates are added to the mixture (protein-hydrocolloid).

9. Method according to claim 8, characterised in that the bi-calcium phosphate is present in a quantity ranging from 0.1% to 0.4% by weight, and preferably 0.2% by weight relative to the total weight of the garnishing material.

10. Method according to claim 1, characterised in that the vegetal protein is chosen from amongst gluten protein, pea protein, lupine protein, soybean protein and their mixture.

11. Method according to claim 1, characterised in that the hydrocolloid is chosen from amongst the alginates, the pectates, and their mixture.

12. Method according to claim 1, characterised in that the recuperated insolubilized protein phase is present in a quantity ranging from 20 to 45% by weight, and preferably from 20 to 35% by weight relative to the total weight of the garnishing and preserving material.

13. Comestible product able to be formed in different geometrical shapes, able to be obtained according to the described method according to any one of claims 1 to 12, comprising a garnishing and preserving material, and a base constituted of animal meat and/or milk products possibly mixed with vegetables and/or fruit, characterised in that said material comprises a vegetal protein and a hydrocolloid present in a protein/hydrocolloid ratio less than or equal to 1 and in that in the base, sodium acetate is substituted by calcium acetate.

14. Product according to claim 13, characterised in that the base comprises calcium acetate.

15. Product according to claim 14, characterised in that the calcium acetate is present in a quantity ranging from 0.1 to 0.6% by weight and preferably from 0.25 to 0.4% by weight relative to the total weight of the base.
